(19) United States
(12) Patent Application Publication
(10) Pub. No.: US 2016/0036629 A1
(43) Pub. Date: Feb. 4, 2016

(54) CONTROL DEVICE, INFORMATION PROCESSING SYSTEM, AND CONTROL METHOD

(71) Applicant: FUJITSU LIMITED, Kawasaki-shi (JP)

(72) Inventors: Daisuke Miyazaki, Kawasaki (JP); Kouji Ueno, Kawasaki (JP); Mamoru Arisumi, Kawasaki (JP); Syoutarou Takanaka, Sagamihara (JP)

(21) Appl. No.: 14/747,251

(22) Filed: Jun. 23, 2015

(30) Foreign Application Priority Data
Jul. 31, 2014 (JP) 2014-156897

(51) Int. Cl. H04L 12/24

(52) U.S. Cl. CPC H04L 41/082; H04L 41/0889

(57) ABSTRACT

A control device includes: a controller configured to control an information processor including a plurality of processing devices, wherein, the controller, based on a program, performs operations to: receive a plurality of processes to be executed by the plurality of processing devices; and select, based on processing information pertaining to the plurality of processes, a second process capable of being executed by a second processing device among the plurality of processing devices during an adjustment time in accordance with an execution of a first process to be executed by a first processing device among the plurality of processing devices, the first process being different from the second process.

### CROSS-REFERENCE TO RELATED APPLICATION

This application is based upon and claims the benefit of priority of the prior Japanese Patent Application No. 2014-156897, filed on Jul. 31, 2014, the entire contents of which are incorporated herein by reference.

### FIELD

The embodiment discussed herein relates to a control device, an information processing system, and a control method.

### BACKGROUND

An information processor called a blade server is provided with a plurality of slots inside a housing. Various types of blade-type devices such as servers, external connection switches, and external storage devices are mounted and coupled to the slots.

A related technique is disclosed in Japanese Laid-Open Patent Publication No. 2002-259147.

### SUMMARY

According to an aspect of the embodiments, a control device includes: a controller configured to control an information processor including a plurality of processing devices, wherein, the controller, based on a program, performs operations to: receive a plurality of processes to be executed by the plurality of processing devices; and select, based on processing information pertaining to the plurality of processes, a second process capable of being executed by a second processing device among the plurality of processing devices during an adjustment time in accordance with an execution of a first process to be executed by a first processing device among the plurality of processing devices, the first process being different from the second process.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an example of a system configuration of an information processing system;

FIG. 2 illustrates an example of a hardware configuration of a management server;

FIG. 3 illustrates an example of a hardware configuration of a management module;

FIG. 4 illustrates an example of a hardware configuration of an external connection switch;

FIG. 5 illustrates an example of processing information data;

FIG. 6 illustrates an example of management processing;

FIG. 7 illustrates an example of interrupt processing;

FIG. 8 illustrates an example of management processing;

FIG. 9 illustrates an example of interrupt processing;

FIG. 10 illustrates an example of total processing times; and

FIG. 11 illustrates an example of task instructions.

### DESCRIPTION OF EMBODIMENT

Slots in a blade server are set with numbers called slot IDs. An information processor called a management module for monitoring and managing the devices coupled to the slots in the blade server is coupled to the slot with the lowest number. An external interface (I/F) for coupling to external devices such as a CD-ROM drive is coupled to the housing of the blade server. The external I/F and the external devices are jointly owned (shared) by a plurality of servers mounted on the blade server.

A system administrator uses the management module when performing work such as firmware updating and setting (referred to hereinbelow as “processing”) on the apparatuses coupled to the slots in this type of blade server. The management module makes the apparatuses specified by the administrator execute the processing in order from the apparatuses coupled the slots with the lowest numbers according to instructions from the system administrator.

The management module makes the apparatuses execute the processing according to the slot number order in the blade server. As a result, when a standby time after executing the processing or a standby time due to competition among the shared hardware such as CD-ROM drives occurs, a certain amount of time may be taken until all the processing is completed. A standby time until a server is activated after the installation of firmware or an operating system (OS) may also be included in the standby time after executing the processing.

As a result, when executing multiple processing in an information apparatus having shared devices, for example, a blade server, the multiple processing is preferably performed concurrently in order to shorten a total processing time

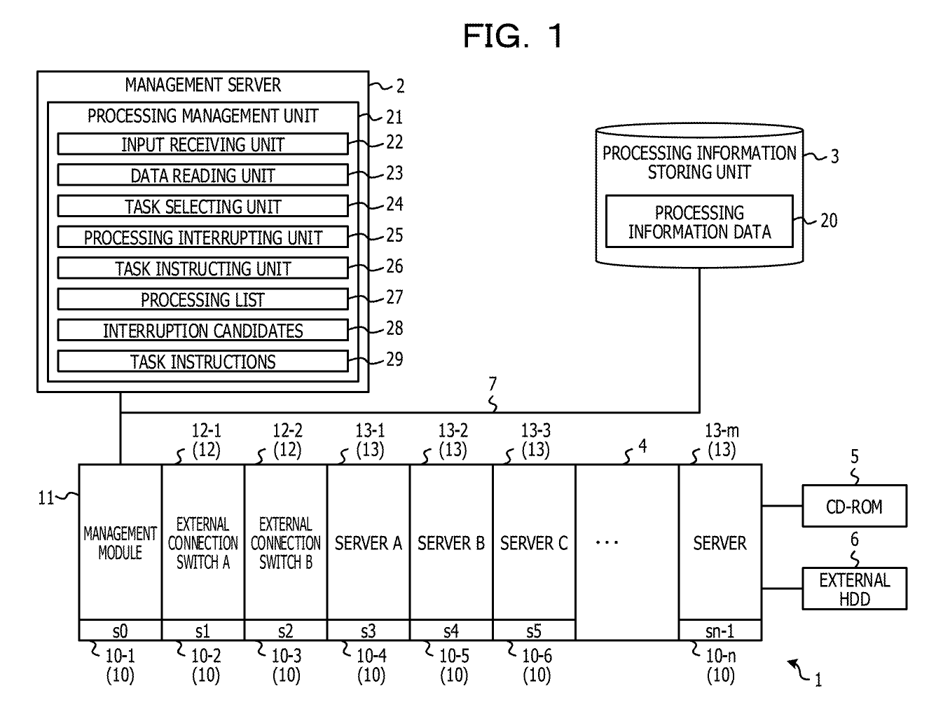

FIG. 1 illustrates an example of a configuration of an information processing system. An information processing system 1 is provided with a management server 2, a processing information storing unit 3, and a blade server 4. The management server 2, the processing information storing unit 3, and the blade server 4 are interconnected by a local area network (LAN) 7. The management server 2 may be an example of a control device and the blade server 4 may be an example of an information processor. The management server 2 may be an information processor provided with a server function and may be provided with a processing management unit 21.

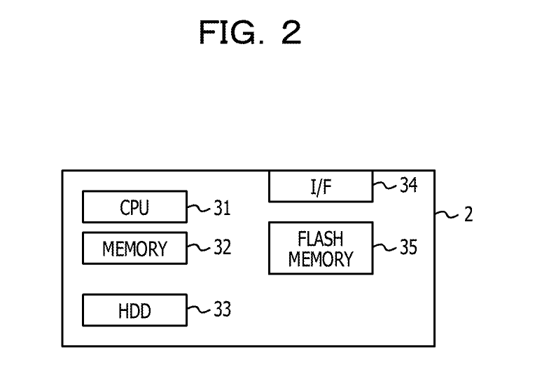

FIG. 2 illustrates an example of a hardware configuration of a management server. The management server 2 illustrated in FIG. 2 may be the management server illustrated in FIG. 1. The management server 2 is provided with a central processing unit (CPU) 31, a memory 32, a hard disk drive (HDD) 33, an interface (I/F) 34, and a flash memory 35. The CPU 31 is a processing device for executing an OS of the management server 2 and for performing various controls and computations to be executed by the management server 2. The CPU 31 reads programs stored in the HDD 33 or the flash memory 35 to execute various types of processing.

The CPU 31 may function as the processing management unit 21, an input receiving unit (receiving unit) 22, a data reading unit 23, a task selecting unit 24, a processing interrupting unit (selecting unit) 25, and a task instructing unit (instructing unit) 26. A conventional CPU may be used as the CPU 31. The memory 32 is a volatile storage region for storing programs executed by the CPU 31 and various data, and for storing data obtained from the operations of the CPU 31. The memory 32 may function as a storage unit for storing interruption candidates 28 and task instructions 29. Various types of existing memories such as a random access memory (RAM) and the like may be used as the memory 32.

The HDD 33 is a storage region for storing various types of data and programs used in processing by the management server 2. The HDD 33 stores control programs. A conventional HDD may be used as the HDD 33. Another storage device such as a solid state drive (SSD) may be used in place of the HDD 33. The I/F 34 is an interface for coupling the management server 2 and external devices, and may be an input/output (I/O) I/F.

The flash memory 35 is a non-volatile storage region for storing various types of data and programs used in processing by the management server 2. A conventional flash memory may be used as the flash memory 35. The blade server 4 is an information processor provided inside the housing with a plurality of slots 10-1 to 10-n (where n is an integer of 2 or greater) for coupling to apparatuses.

The slots 10-1 to 10-n may be I/Fs conforming to various types of standards such as the 64-bit PCI-X standard or the PCI Express standard. Hereinbelow, reference numbers 10-1 to 10-n are used as the reference numeral for the slots when specifying one of the plurality of slots, and the reference numeral 10 is used when referring to one or more arbitrary slots. The slots 10-1 to 10-n may also be referred to as slots s0 to sn-1, respectively.

Blade-type apparatuses which can be inserted and removed such as the management module 11, external connection switches 12-1 and 12-2, and servers 13-1 to 13-m (where m is an integer no less than 1) are respectively coupled in order to the slots 10-1 to 10-n of the blade server 4. The management module 11, the external connection switches 12-1, 12-2, and the servers 13-1 to 13-m connected to the slots 10-1 to 10-n of the blade server 4 may be referred to collectively hereinbelow as “apparatuses” (processing devices).

Reference numerals 12-1 and 12-2 are used below when specifying one of the plurality of external connection switches as the reference numerals for indicating an external connection switch, and the reference numeral 12 is used when indicating one or more arbitrary external connection switches. The external connection switches 12-1 and 12-2 may be referred to respectively as the external connection switch A and the external connection switch B. Reference numerals 13-1 to 13-m are used below as the reference numerals for indicating a server when specifying one of the plurality of servers, and the reference numeral 13 is used when referring to one or more arbitrary servers. The servers 13-1, 13-2, 13-3, . . . may be referred to respectively as servers A, B, C, . . . .

An CD-ROM drive such as the CD-ROM drive 5 depicted in FIG. 1 or an external HDD such as the external HDD 6 depicted in FIG. 1 is coupled to the blade server 4 via an I/F provided in the housing. The CD-ROM drive 5 and the external HDD 6 are shared (jointly owned) among the servers 13-1 to 13-m. The CD-ROM drive 5 and the external HDD 6 may be referred to collectively below as “shared hardware”.

The management module 11 manages various apparatuses coupled to the housing of the blade server 4 or to the slots 10 of the blade server 4. The management module 11 is an information processor for managing and monitoring the connection switches 12, the servers 13 and so on and for controlling the sharing of the shared hardware among the servers 13. The management module 11 receives task instructions 29 from the task instructing unit 26 of the management server 2 and controls the various apparatuses of the blade server 4 to execute the tasks.

A “task” indicates a process to be executed by the various apparatuses in the blade server 4. The processing to be executed by the apparatuses as tasks may include performing updates of the firmware of the apparatuses, firmware settings, operation settings, OS installations, OS settings, or external connection settings. The processing related to the configuration of the apparatuses such as performing updates of the firmware of the apparatuses in the blade server 4, firmware settings, operation settings, OS installations, OS settings, or external connection settings may be referred to below as “setting processing”.

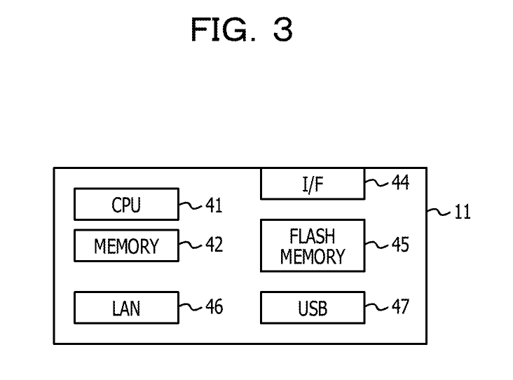

FIG. 3 illustrates an example of a hardware configuration of a management module. The management module 11 is provided with a CPU 41, a memory 42, an I/F 44, a flash memory 45, a LAN adaptor (indicated as “LAN” in FIG. 3) 46, and a Universal Serial Bus (USB) connector 47 indicated by USB in FIG. 3.

The CPU 41 is a processing device for executing the OS of the management module 11 and for performing various controls and computations to be executed by the management module 11. The CPU 41 reads programs stored in the flash memory 45 to execute various types of processing. A conventional CPU may be used as the CPU 41. The memory 42 is a volatile storage region for storing programs executed by the CPU 41 and various data, and for storing data obtained from the operations of the CPU 41. Various types of existing memories such as a RAM and the like may be used as the memory 42.

The I/F 44 may be an interface for coupling the management module 11 and the external devices and may be an I/O I/F. The flash memory 45 is a non-volatile storage region for storing various types of data and programs used in processing by the management module 11. A conventional flash memory may be used as the flash memory 45.

The LAN adaptor 46 is an adaptor for coupling the management module 11 to external information processors or storage devices via the LAN 7. A conventional LAN adaptor for example may be used as the LAN adaptor 46. The USB connector 47 is a connector for coupling the management module 11 to an external USB-applicable apparatus. A conventional USB connector may be used for example as the USB connector 47.

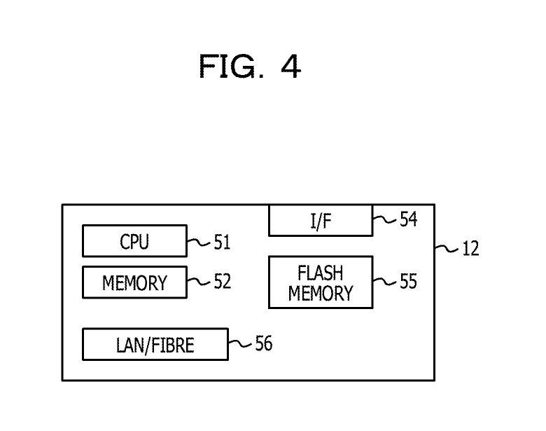

The external connection switches 12 are blade-type data relay devices for coupling the blade server 4 to external devices such as a network apparatus. FIG. 4 illustrates an example of a hardware configuration of an external connection switch. The external connection switches 12 are each provided with a CPU 51, a memory 52, an I/F 54, a flash memory 55, and a LAN/fiber adaptor 56 indicated as LAN/fiber in FIG. 4.

The CPU 51 is a processing device for executing the OS of the external connection switches 12 and for performing various controls and computations to be executed by the external connection switches 12. The CPU 51 reads programs stored in the flash memory 55 to execute various types of processing. A conventional CPU may be used as the CPU 51. The memory 52 is a volatile storage region for storing programs to be executed by the CPU 51 and various data, and for storing data obtained from the operations of the CPU 51. Various types of existing memories such as a RAM and the like may be used as the memory 52.

The I/F 54 may be an interface for coupling the external connection switches 12 and the external devices and may be an I/O I/F. The flash memory 55 is a non-volatile storage region for storing various types of data and programs to be used in processing by the external connection switches 12. A conventional flash memory may be used as the flash memory 55.

The LAN/fiber adaptor 56 is an adaptor for coupling the external connection switches 12 to external information processors or storage devices via the LAN 7 or a fiber channel. A conventional LAN adaptor or fiber adaptor may be used as the LAN/fiber adaptor 56. The servers 13 are blade-type information processors provided with server functions and are used by the user of the information processing system 1 for working via a terminal device. The servers 13 may have substantially the same or similar hardware configurations as the management server 2 illustrated in FIG. 2. As a result, a detailed explanation and illustration of the configurations may be omitted or reduced in FIG. 4.

The processing management unit 21 of the management server 2 manages various types of processing executed in the blade server 4. The processing management unit 21 controls the processing executed by the apparatuses in the blade server 4 so as to shorten an overall processing time of the entire blade server 4 based on the configurations of the apparatuses mounted in the blade server 4, the processing execution times and the standby times, or the resource activity rates of the apparatuses. For example, the processing management unit 21 determines processing to be executed by the apparatuses of the blade server 4 and determines processing to be executed parallel to the execution of the determined processing during the standby times generated in accompaniment to the execution of determined processing so that the overall processing time of the entire blade server 4 is shortened.

The sum of the execution times for executing specific processing by the apparatuses and the standby times generated in accompaniment to the execution of this processing may be referred to below as “processing time”. An adjustment time for adjusting generated in accompaniment to the execution of the processing is often generated as the standby time after the execution of the processing, and thus the adjustment time may be referred to as “standby time” hereinbelow, and standby time after the execution time of the processing may be generated. For example, the standby time (adjustment time) may be generated at any timing before or after the execution of the processing. The adjustment time may not be the standby time.

As illustrated in FIG. 1, the processing management unit 21 is provided with an input receiving unit 22, a data reading unit 23, the task selecting unit 24, a process interrupting unit 25, the task instructing unit 26, a processing list 27, the interruption candidates 28, and the task instructions 29. The input receiving unit 22 receives from the administrator (user) the input of processing to be executed by the apparatuses of the blade server 4. For example, the input receiving unit 22 receives the input of a number (slot ID) of the slot 10 coupled to an apparatus to execute processing and an ID of the processing to be executed.

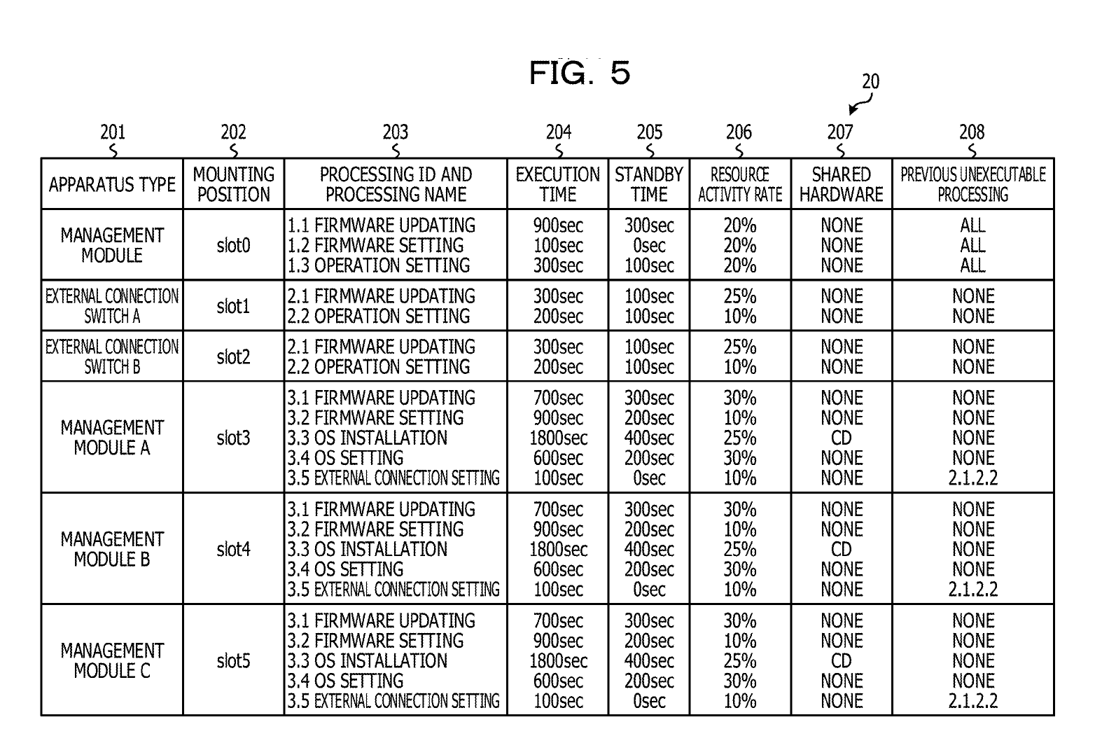

The data reading unit 23 reads processing information data 20 from the processing information storing unit 3. The task selecting unit 24 specifies the apparatus having the largest value of the total processing time (execution time 204+standby time 205 of the processing information data 20; see FIG. 5) of the entire processing from the apparatuses subject to the processing received by the input receiving unit 22 based on the processing information data 20 read by the data reading unit 23. If a plurality of apparatuses have the longest processing time, the task selecting unit 24 selects the apparatus having the lowest slot ID of the slots 10 coupled to the apparatuses among the plurality of apparatuses. For example, if the total processing times of the server A and the server B are the same and are the longest, the task selecting unit 24 may select the server A that is coupled to the slot s3.

The task selecting unit 24 records all the processing to be executed by the selected apparatus and the order of the execution in the task instructions 29 as at least one task. For example, a “task” refers to a collection of one or more processes (execution time and/or standby time). Hereinbelow, the selection of a series of processes as a task and the recording thereof in the task instructions 29 may be referred to as “assigning processing as a task”.

The process interrupting unit 25 determines processing that can be executed in the standby time generated in accompaniment to the processing assigned by the task selecting unit 24 as a task based on the processing information data 20 read by the data reading unit 23, so that the overall processing time of the entire blade server 4 is shortened. For example, the process interrupting unit 25 determines processing that can be executed during the standby time so that the overall processing time of the entire blade server 4 is shortened based on the configurations of the apparatuses mounted in the blade server 4, the priority sequence of the processing, the execution times and the standby times of the processing, and the resource activity rates of the apparatuses. The priority sequence of the processing, for example, allows for a higher priority sequence for processing in which the value of the processing ID of the processing is lower. If the processing IDs are the same, the priority sequence of the processing may be determined so that the apparatus with a smaller slot ID has a higher priority level. The processing performed by the process interrupting unit 25 may be referred to as “interruption processing”.

The task instructing unit 26 transfers information (task instructions 29) of a task determined by the process interrupting unit 25 to the management module 11 of the blade server 4 to cause the management module 11 to start the task.

The processing list 27 is a temporary file for storing a list of unassigned processing as tasks, and is used in processing by the task selecting unit 24 and the process interrupting unit 25. The processing list 27 is temporarily stored for example in the memory 32 of the management server 2. Interruption candidates 28 are a temporary file for storing processing that can be interrupted during the processing previously assigned as tasks among the processing unassigned as tasks that is the processing list 27. The interruption candidates 28 are used in the interruption processing by the process interrupting unit 25. The interruption candidates 28 are temporarily stored for example in the memory 32 of the management server 2.

The task instructions 29 include information of processing assigned to tasks as processing to be executed by the apparatuses of the blade server 4. For example, the number (slot ID) of the slot 10 coupled to the apparatus for executing processing, and processing name and the ID of the processing to be executed, and the execution time and the standby time of the processing are described in the task instructions 29. The task instructions 29 are created in a plain text format, for example, in the memory 32 of the management server for example.

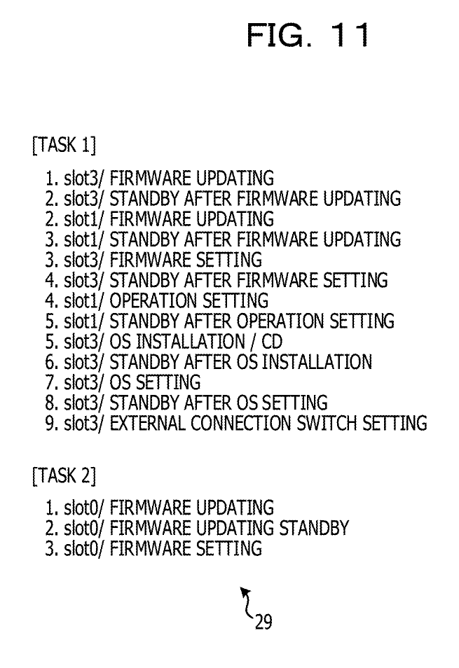

FIG. 11 illustrates an example of task instructions. A number, a slot ID, and a task name are listed for each task in the task instructions 29 illustrated in FIG. 11. Processing having the same number may be executed at substantially the same time. For example, the firmware updating in slot 3 may be executed concurrently with the firmware updating in slot 0 in FIG. 11. Next, the standby after the firmware updating in the slot 3, the firmware updating in slot 1, and the standby after the firmware updating in the slot 0 are executed at substantially the same time.

The processing information storing unit 3 is a storage unit for storing the processing information data 20 pertaining to various settings pertaining to the processing in the information processing system 1, and may be a storage device for example. FIG. 5 illustrates an example of processing information data. The processing information data 20 includes information (processing information) pertaining to the processing executed in the blade server 4.

The processing information data 20 includes an apparatus type 201, a mounting position 202, a processing ID and processing name 203, an execution time 204, a standby time 205, a resource activity rate 206, a shared hardware 207, and a previous unexecutable processing 208 as items which are stored in association with each other. The apparatus type 201 includes information (e.g., name of apparatus) indicating the apparatus mounted in the blade server 4.

The mounting position 202 includes information (e.g., slot ID) indicating the slot 10 in which the apparatus is coupled. The processing ID and processing name 203 may include information indicating the processing to be performed by the apparatus, for example, the processing ID+processing name such as “1.1,” illustrated in FIG. 5. The execution time 204 includes an estimated value of the execution time of the processing indicated in the processing ID and processing name 203, and includes, for example, the execution time used for executing the processing. For example, the execution time 204 may be an average of the execution times during which the processing was executed in the past in the blade server 4, and the average is recalculated and updated each time the processing is executed in the blade server 4.

The standby time 205 includes an estimated value of a standby time generated accompanying the execution of the processing indicated in the processing ID and processing name 203. For example, a standby time generated with the execution of the processing may be included. For example, the standby time 205 is an average value of standby times when the processing has been executed in the past in the blade server 4, and the average value is recalculated and updated each time the processing is executed in the blade server 4. The standby time 205 may correspond to the adjustment time.

The resource activity rate 206 includes the activity rates of resources such as CPUs and memories used in the processing indicated in the processing ID and processing name 203. For example, the resource activity rate 206 is recalculated and updated each time the processing is executed in the blade server 4. The shared hardware (shared devices) 207 indicates the presence or absence of the usage of shared hardware in the processing indicated in the processing ID and processing name 203. The items in this field may be specified by the system administrator. For example, “none” is specified if no shared hardware is used, and “CD” may be specified if the CD-ROM drive 5 is used as the shared hardware.

The previous unexecutable processing 208 indicates the processing ID for processing that is not allowed to be executed before the processing indicated in the processing ID and processing name 203. The items in this field may be specified by the system administrator. For example, the setting of the external connection switch 12 and the servers 13 is not performed until after the management module 11 has been set. As a result, “all” is specified in FIG. 5 for the previous unexecutable processing 208 for all processing of the management module 11. The “3.5 External connection setting” is not executed until after the setting of the external connection switch 12. As a result, “2.1, 2.2” are specified in the previous unexecutable processing 208 for the “3.5 External connection setting”.

A control program for executing the functions of the processing management unit 21, the input receiving unit 22, the data reading unit 23, the task selecting unit 24, the process interrupting unit 25, and the task instructing unit 26 may be provided in a format recorded on a computer-readable storage medium such as a flexible disk, a CD (CD-ROM, CD-R, CD-RW), a DVD (DVD-ROM, DVD-RAM, DVD-R, DVD+R, DVD-RW, DVD+RW, HD DVD), a Blu-ray disk, a magnetic disc, an optical disk, or a magneto-optic disc. In this case, the computer reads the program from the recording medium and uses the program by transferring and storing the program into an internal storage device or an external storage device. The program may be recorded on a storage device (recording medium) such as a magnetic disc, an optical disk, or a magneto-optic disc and provided to a computer from the storage device through a communication path.

When the functions of the processing management unit 21, the input receiving unit 22, the data reading unit 23, the task selecting unit 24, the process interrupting unit 25, and the task instructing unit 26 are executed, a control program of the information processor stored in an internal storage device such as the HDD 33 in the management server 2 is executed by a microprocessor such as the CPU 31 in the management server 2 of a computer. At this time, the program recorded on the recording medium may be read and executed by the computer.

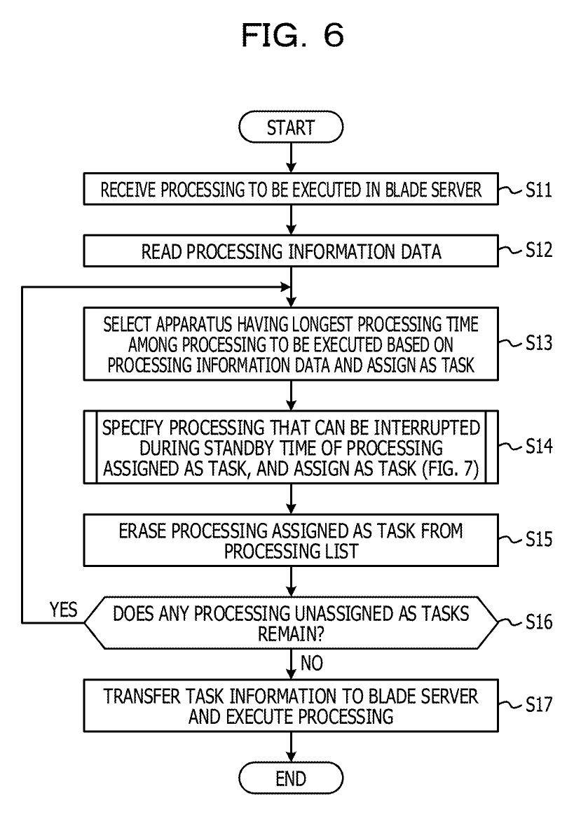

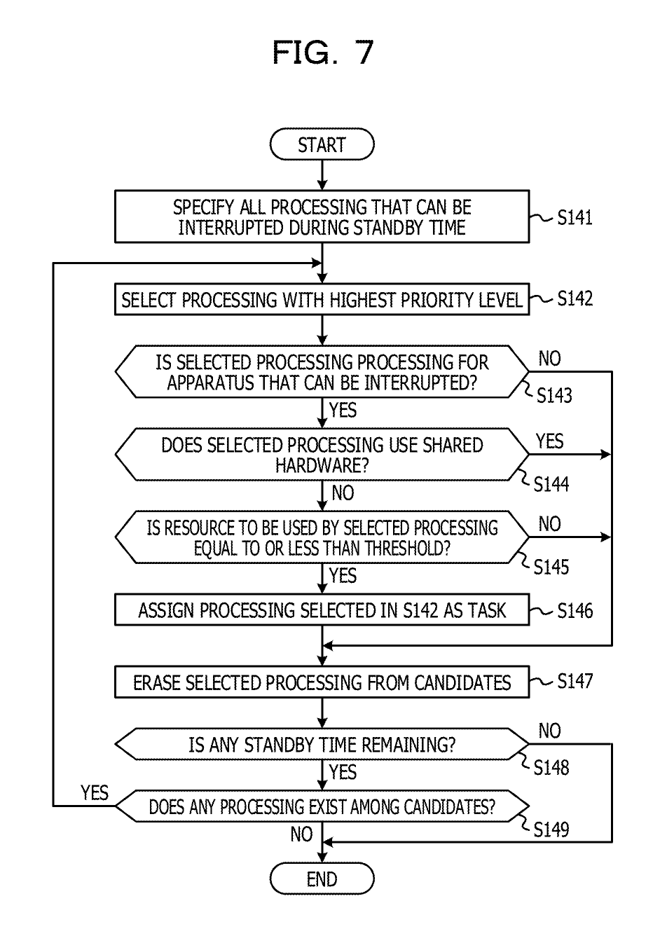

FIG. 6 illustrates an example of management processing. The processing management unit 21 illustrated in FIG. 1 may execute the management processing illustrated in FIG. 6. FIG. 7 illustrates an example of interrupt management. The process interrupting unit 25 illustrated in FIG. 1 may execute the interruption processing illustrated in FIG. 7. In operation S11 in FIG. 6, an administrator of the information processing system 1 such as the user inputs processing to be executed in the blade server 4 into the management server 2. The administrator selects processing for performing firmware updating or setting for the various apparatuses, for example, in the blade server 4. The input receiving unit 22 of the processing management unit 21 in the management server 2 receives the processing input by the administrator, creates the processing list 27, and records all the received processing.

The processing list 27 may be recreated each time this processing is executed. In operation S12, the data reading unit 23 reads the processing information data 20 (see FIG. 5) from the processing information storing unit 3. In operation S13, the task selecting unit 24 specifies the apparatus with the longest value that is a sum of the processing times (execution time 204+standby time 205 in the processing information data 20) of all the processing from among the apparatuses for executing the processing indicated in the processing list 27 based on the processing information data 20.

The task selecting unit 24 records all the processing to be executed by the selected apparatus and the order of the execution in the task instructions 29 as tasks. In operation S14, the process interrupting unit 25 executes the interruption processing and specifies processing that can be executed in the standby time for the processing among the tasks assigned by the task selecting unit 24 in operation S13.

For example, in operation S141 in FIG. 7, the process interrupting unit 25 searches for processing that can be executed during the standby time of the processing indicated in the task instructions 29 from the processing list 27, based on the values of the execution time 204, the standby time 205, and the previous unexecutable processing 208 in the processing information data 20. The interruption candidates 28 are created and all the searched processing may be indicated. The process interrupting unit 25 specifies processing having an execution time recorded in the processing information data 20 that is equal to or less than the standby time of the processing among the tasks indicated in the task instructions 29 and is not excluded by the previous unexecutable processing 208, and records the specified processing in the interruption candidates 28.

The interruption candidates 28 may be recreated each time this processing is executed. In operation S142, the process interrupting unit 25 selects the processing with the highest priority level among the processing recorded in the interruption candidates 28 in operation S141. For example, processing with smaller processing ID values may has correspondingly higher priority levels, and if the processing ID is the same, apparatuses with lower slot IDs may have correspondingly higher priority levels. The “2.1 Firmware updating” having the lower processing ID has a higher priority level than the “3.1 Firmware updating” in FIG. 5. The “3.1 Firmware updating” processing of the server A coupled to a lower slot ID has a higher priority level than the “3.1 Firmware updating” processing of the server B.

In operation S143, the process interrupting unit 25 determines whether the processing selected in operation S142 is processing for apparatuses that can be executed concurrently. If the processing is not processing for apparatuses that can be executed concurrently (see operation S143: No route), the process advances to operation S147. If the processing is processing for apparatuses that can be executed concurrently (see operation S143: Yes route), the process interrupting unit 25 determines in operation S144 whether the processing selected in operation S142 uses shared hardware (the CD-ROM drive 5, the external HDD 6, etc.).

If shared hardware is used (see operation S144: Yes route), the process advances to operation S147. If no shared hardware is used (see operation S144: No route), the process interrupting unit 25 determines in operation S145 whether a total resource activity rate is at or below a threshold when the processing is executed concurrently. For example, the process interrupting unit 25 determines whether resource activity rates such as the activity rate of the CPU 31 or the activity rate of the memory 32 in the management module 11 are equal to or less than a threshold (e.g., 100%).

If the total resource activity rate exceeds the threshold (see operation S145: No route), the process advances to operation S147. If the total resource activity rate does not exceed the threshold (see operation S145: Yes route), the processing selected in operation S142 may be executable. As a result, the process interrupting unit 25 assigns the processing selected in operation S142 as a task in operation S146. For example, the selected processing may be recorded in the task instructions 29 as a task.

The process interrupting unit 25 erases the processing selected in operation S142 from the interruption candidates 28 in operation S147. The process interrupting unit 25 may erase the processing regardless of whether or not the processing is assigned in operation S146. In operation S148, the process interrupting unit 25 determines whether any standby time in which processing is not interrupted remains.

If the processing has been interrupted to all of the standby times (see operation S148: No route), the process is completed. If any standby time in which the processing is not interrupted remains (see operation S148: Yes route), the process interrupting unit 25 determines whether any processing in the interruption candidates 28 remains in operation S149.

If processing in the interruption candidates 28 remains (see operation S149: Yes route), the process returns to operation S142. If no processing in the interruption candidates 28 remains (see operation S149: No route), the process moves to operation S15 in FIG. 6. In operation S15, processing assigned as tasks among the processing up to this point is erased from the processing list 27.

In operation S16, the task selecting unit 24 determines whether unassigned processing as the task, such as processing not recorded in the task instructions 29, remains in the processing list 27. If processing remains in the processing list 27 (see operation S16: Yes route), the process returns to operation S13.

If no processing remains in the processing list 27 (see operation S16: No route), all the processing is assigned as tasks. As a result, in operation S17, the task instructing unit 26 transfers the task instructions 29 to the blade server 4 in order to allow the blade server 4 to start the execution of the tasks, and the process is completed.

For example, the administrator of the information processing system 1, such as the user, may cause the blade server 4 to execute the following processing.
Execute “Firmware updating” and “Firmware setting” in the management module 11 mounted in the slot s0.
Execute “Firmware updating” and “Operation setting” in the external connection switch A mounted in the slot s1.
Execute “Firmware updating”, “Firmware setting”, “CD-ROM drive 5 (CD usage)”, “OS setting”, and “External connection setting” in the server A mounted in the slot s3.

For example, the processing information data 20 illustrated in FIG. 5 may be used as the processing information data 20.

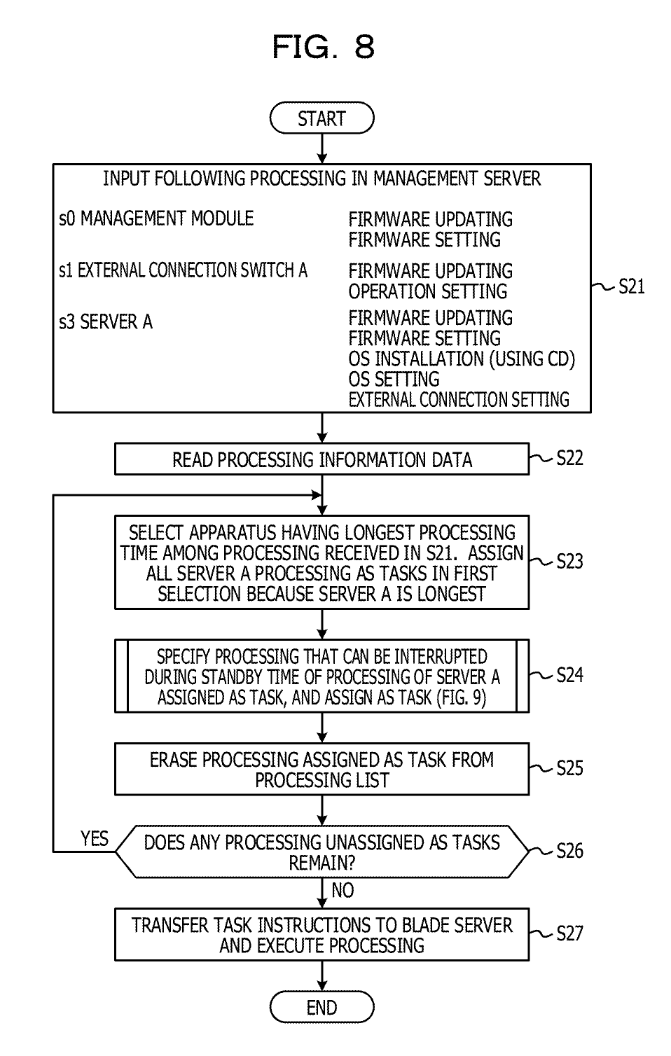

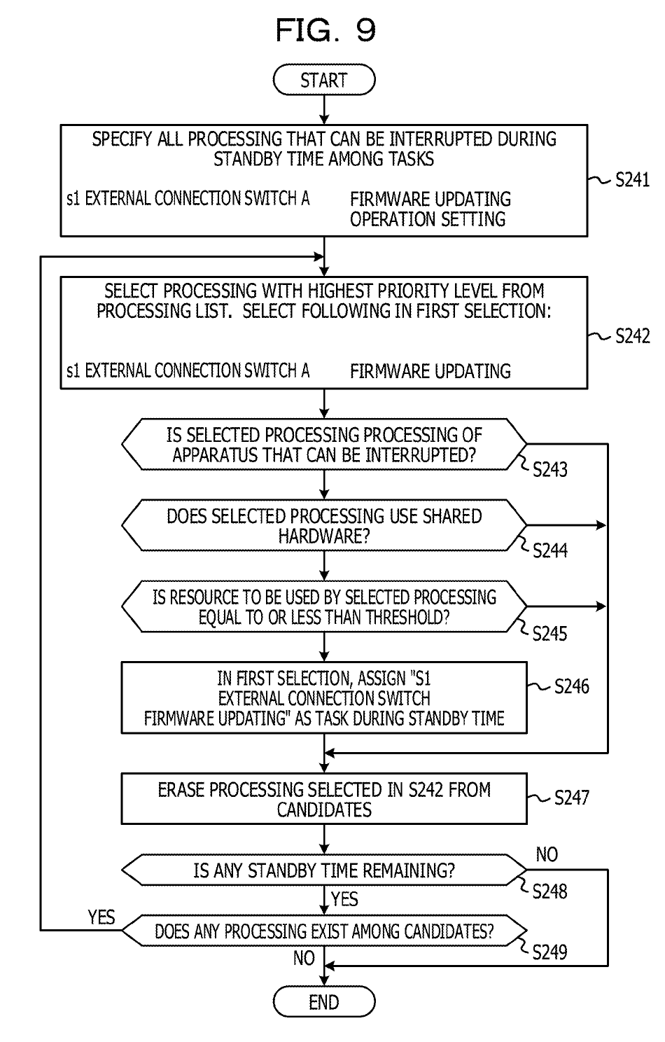

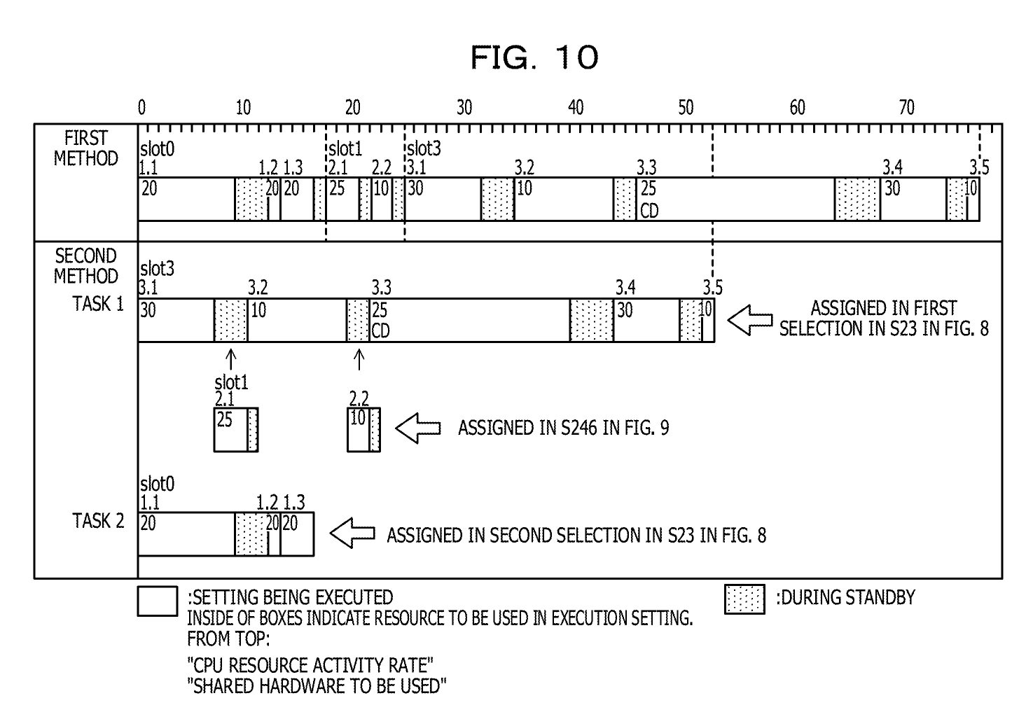

FIG. 8 illustrates an example of management processing. FIG. 9 illustrates an example of interrupt management. The management processing illustrated in FIG. 8 may correspond to the management processing illustrated in FIG. 6, and the interruption processing illustrated in FIG. 9 may correspond to the interruption processing illustrated in FIG. 7. FIG. 10 illustrates an example of total processing times. In operation S21 in FIG. 8, the administrator inputs processing contents as described in operation S21 in FIG. 8 such as commands into the management server 2.

In operation S22, the input receiving unit 22 of the processing management unit 21 in the management server 2 receives the processing contents input by the administrator, creates the processing list 27, and records all the received processing. In operation S23, the apparatus is specified with the longest value that is a total of the processing times (execution time 204+standby time 205 in the processing information data 20) of all the processing from among the apparatuses for executing the processing indicated in the processing list 27. For example, using the values illustrated in FIG. 5, the total processing time of each of the apparatuses may be derived as follows.
Total processing time of the management module 11 (slot 0)=“Firmware updating” (900+300)+“Firmware setting” (100+0)=1300 seconds
Total processing time of the external connection switch A (slot 1)=“Firmware updating” (300+100)+“Operation setting” (200+100)=700 seconds
Total processing time of the server A (slot 3)=Firmware updating” (700+300)+“Firmware setting” (900+200)+OS installation (CD usage) (1800+400)+OS setting (600+200)+External connection setting (100+0)=5200 seconds

For example, the task selecting unit 24 specifies the server A having the longest total of the processing times at 5200 seconds among the processing inputted by the administrator in operation S21.

The task selecting unit 24 assigns all the processing to be executed by the selected apparatus (the server A) and the order of the execution as tasks. In operation S24, the process interrupting unit 25 executes the interruption processing and specifies the processing that can be executed during the standby time of the processing among the tasks assigned by the task selecting unit 24 in operation S23.

For example, in operation S241 in FIG. 9, the process interrupting unit 25 specifies the processing that can be executed in the standby time of the processing indicated in the task instructions 29 from the processing list 27, based on the values of the execution time 204, the standby time 205, and the previous unexecutable processing 208 in the processing information data 20. The interruption candidates 28 are created and the searched processing is indicated. For example, the respective standby times for the processing among the tasks assigned in operation S24 illustrated in FIG. 8 may be 300 seconds, 200 seconds, 400 seconds, 200 seconds, and 0 seconds.

The process interrupting unit 25 specifies and records, in the interruption candidates 28, two processes made up of the “Firmware updating” (execution time=300 seconds) of the external connection switch A (slot 1) and the “Operation setting” (execution time=200 seconds) of the external connection switch A (slot 1). In operation S242, the process interrupting unit 25 selects the processing with the highest priority level among the processing recorded in the interruption candidates 28 in operation S241. Because the processing with the lowest processing ID value has the highest priority level, the process interrupting unit 25 may for example select the “Firmware updating” of the external connection switch A (slot 1).

In operation S243, the process interrupting unit 25 determines whether the “Firmware updating” of the external connection switch A (slot 1) selected in operation S242 is processing for an apparatus that allows parallel execution. Because the “Firmware updating” of the external connection switch A (slot 1) selected in operation S242 indicates “none” as the previous unexecutable processing 208 value corresponding to the processing information data 20, the “Firmware updating” of the external connection switch A (slot 1) allows parallel execution. As a result, the process interrupting unit 25 in operation S244 determines whether the “Firmware updating” of the external connection switch A (slot 1) uses shared hardware such as the CD-ROM drive 5 or the external HDD 6.

Because no shared hardware is used, the process interrupting unit 25 determines in operation S245 whether the total resource activity rate is at or below the threshold even if the processing is executed in parallel. For example as illustrated in FIG. 10, because the resource activity rate of the “Firmware updating” of the server A (slot 3) is 20%, and the resource activity rate of the “Firmware updating” of the external connection switch A (slot 1) is 25%, the total resource activity rate is 45% which is less than 100% and thus does not exceed the threshold. In operation S246, the process interrupting unit 25 may assign the “Firmware updating” of the external connection switch A (slot 1) as a task and record the “Firmware updating” of the external connection switch A (slot 1) as a task in the task instructions 29.

In operation S247, the process interrupting unit 25 erases the “Firmware updating” of the external connection switch A (slot 1) from the interruption candidates 28. In operation S248, the process interrupting unit 25 determines whether any standby time in which the processing is not interrupted remains. If standby time in which the processing is not interrupted remains (see operation S248: Yes route), the process interrupting unit 25 determines whether any processing in the interruption candidates 28 remains in operation S249.

Because the “Operation setting” (execution time=200 seconds) of the external connection switch A (slot 1) remains in the interruption candidates 28, the process returns to operation S242. For example, the processing in operations S242 to S248 may be executed and the processing may be selected. If no processing in the interruption candidates 28 remains, the process moves to operation S25 in FIG. 8.

In operation S25, operations assigned as tasks among the operations up to this point are erased from the processing list 27. In operation S26, the task selecting unit 24 determines whether unassigned processing as tasks, such as processing not recorded in the task instructions 29, remains in the processing list 27.

If processing remains in the processing list 27 (see operation S26: Yes route), the process returns to operation S23. For example, all the processing executed in the management module 11 may be selected in operations S23 to S26. Because all the processing executed in the management module 11 is selected, no processing remains.

As a result in operation S27, the task instructing unit 26 transfers the task instructions 29 to the blade server 4 in order to allow the blade server 4 to start the execution of the tasks, and the process is completed. The input receiving unit 22 receives the processing to be executed in the blade server 4. The task selecting unit 24 determines the processing to be executed by the blade server 4 based on the processing information data 20 read by the data reading unit 23. The process interrupting unit 25 determines the processing to be executed in parallel with the standby time of the processing selected by the task selecting unit 24 so that the overall processing time of the entire blade server 4 is shortened. In this way, different processing to be executed in parallel during the standby time is selected. As a result, different processing, such as different setting processing, is executed during the long standby time due to competition between shared hardware such as the CD-ROM drive 5 in, for example, the setting processing for the apparatuses. Thus the overall processing time of the blade server 4 may be shortened.

The upper portion in FIG. 10 illustrates the overall processing time of a blade server based on a first method, and the lower portion in FIG. 10 illustrates the overall processing time of a blade server based on a second method. The second method may be the method used by the processing management unit 21 illustrated in FIG. 1 for example. In either case, the processing described in FIG. 8 and FIG. 9 is executed, and the processing ID, the execution time, and the standby time correspond to the example illustrated in FIG. 5. In FIG. 10, the overall processing time in the second method is 5200 seconds which is shortened by 2400 seconds (40 minutes) from the first method of 7600 seconds.

In this way, the entire working time of the work of the blade server 4 such as setting and the like may be shortened.

For example, the processing management unit 21 may manage the processing of the blade server 4 and the processing management unit 21 may manage the processing of an information processor other than a blade server. Two external connection switches 12 may be provided in the blade server 4, and the number of the external connection switches 12 may be two or more. The number of units of other hardware may also be modified as appropriate.

The processing information storing unit 3 may be provided as an independent storage device, or the processing information storing unit 3 may be provided locally in the management server 2. For example, the processing information storing unit 3 may be provided in the HDD 33 or the flash memory 35 of the management server 2. The information of the processing information data 20 may be updated by the management server 2 each time processing of the blade server 4 is executed. For example, the information of the processing information data 20 previously set by the administrator may not be updated.

While the task instructions 29 in a plain text format are illustrated in FIG. 11, the task instructions 29 in another format may be used.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A control device comprising:
a controller configured to control an information processor including a plurality of processing devices, wherein,
the controller, based on a program, performs operations to:
receive a plurality of processes to be executed by the plurality of processing devices; and
select, based on processing information pertaining to the plurality of processes, a second process capable of being executed by a second processing device among the plurality of processing devices during an adjustment time in accordance with an execution of a first process to be executed by a first processing device among the plurality of processing devices, the first process being different from the second process.

2. The control device according to claim 1, wherein
the controller transmits an instruction of executions of the first process and the second process to a management device, provided in the information processor, configured to control the first processing device and the second processing device.

3. The control device according to claim 1, wherein,
the information processor includes a shared device to be shared by the plurality of processing devices, and
the controller selects the second process based on the presence or absence of usage of the shared device.

4. The control device according to claim 3, wherein,
the controller selects, as the second process, a process without using the shared device when the shared device is used in the first process.

5. The control device according to claim 1, wherein,
the processing information includes an execution time and an adjustment time for each of the plurality of processes.

6. The control device according to claim 5, wherein,
the first processing device has a longest total time of the execution time and the adjustment time of all processes executed by the first processing device.

7. The control device according to claim 5, wherein,
the first process is a setting process, and the controller selects, as the second process, another setting process capable being executed during the adjustment time in accordance with the execution of the setting process.

8. The control device according to claim 2, wherein,
the management device is the first processing device or the second processing device.

9. An information processing system, comprising:
an information processor including a plurality of processing devices; and
a control device coupled to the information processor,
wherein the control device, based on a program, performs operations to:
receive a plurality of processes to be executed by the plurality of processing devices; and
select, based on processing information pertaining to the plurality of processes, a second process capable of being executed by a second processing device among the plurality of processing devices during an adjustment time in accordance with an execution of a first process to be executed by a first processing device among the plurality of processing devices, the first process being different from the second process.

10. The information processing system according to claim 9, wherein
the control device transmits an instruction of executions of the first process and the second process to a management device, provided in the information processor, configured to control the first processing device and the second processing device.

11. The information processing system according to claim 9, wherein,
a shared device to be shared by the plurality of processing devices is coupled to the information processor, and
the control device selects the second process based on the presence or absence of usage of the shared device.

12. The information processing system according to claim 11, wherein,
the control device selects, as the second process, a process without using the shared device when the shared device is used in the first process.

13. The information processing system according to claim 9, wherein,
the processing information includes an execution time and an adjustment time for each of the plurality of processes.

14. The information processing system according to claim 13, wherein,
the first processing device has a longest total time of the execution time and the adjustment time of all processes executed by the first processing device.

15. A control method, comprising:
receiving a plurality of processes to be executed by a plurality of processing devices; and
selecting, by a processor, based on processing information pertaining to the plurality of processes, a second process capable of being executed by a second processing device among the plurality of processing devices during an adjustment time in accordance with an execution of a first process to be executed by a first processing device among the plurality of processing devices, the first process being different from the second process.

16. The control method according to claim 15, wherein,
the selecting of the second process is performed based on the presence or absence of usage of a shared device to be shared by the plurality of processing devices.

17. The control method according to claim 16, wherein,
a process without using the shared device when the shared device is used in the first process is selected as the second process.

18. The control method according to claim 15, wherein,
the processing information includes an execution time and an adjustment time for each of the plurality of processes.

19. The control method according to claim 18, wherein,
the first processing device has a longest total time of the execution time and the adjustment time of all processes executed by the first processing device.

20. The control method according to claim 18, wherein,
the first process is a setting process, and another setting process capable being executed during the adjustment time in accordance with the execution of the setting process is selected as the second process.
